(19) United States
(12) Patent Application Publication
(10) Pub. No.: US 2021/0046767 A1
(43) Pub. Date: Feb. 18, 2021

(54) REGIONAL PIXEL ACTIVATIONS

(71) Applicant: Hewlett-Packard Development Company, L.P., Spring, TX (US)

(72) Inventors: Jason M Quintana, Vancouver, WA (US); Jay S Gondek, Vancouver, WA (US)

(21) Appl. No.: 16/981,422

(22) PCT Filed: Apr. 30, 2018
(86) PCT No.: PCT/US2018/030304

§ 371 Date: Sep. 16, 2020

(51) Int. Cl. B41J 2/365; B41J 29/393; B41J 2/045

(52) U.S. Cl. CPC B41J 2/365; B41J 2/0458; B41J 29/393

(57) ABSTRACT

An example system for a thermal printing device may comprise a printhead comprising a heat source, where the printhead is to transmit heat from the heat source onto a thermally activated print medium to form markings on a plurality of regions of the thermally activated print medium to form a pixel, and a controller to determine a plurality of voltage pulse patterns prior to formation of the markings on the plurality of regions, determine which of the plurality of regions the plurality of voltage pulse patterns are to activate prior to formation of the markings on the plurality of regions, where the plurality of regions comprise regions with overlapping color layers onto which markings are to be formed with an individual pulse pattern of the plurality of voltage pulse patterns, and send a voltage pulse pattern information to the printhead.

### BACKGROUND

Imaging systems, such as printers, copiers, etc., may generate text or images onto print media (e.g., paper, plastic, etc.). In some examples, imaging systems may perform a print job comprising printing text and/or images by manipulating the print medium.

### BRIEF DESCRIPTION OF THE DRAWINGS

FIG. 1 illustrates an example system including a thermal printing device.

FIG. 2 illustrates an example apparatus including a thermal printing device.

FIG. 3 illustrates an example thermal printing device.

FIG. 4 illustrates an example diagram of a medium including a thermal printing device.

### DETAILED DESCRIPTION

Thermal printing devices may apply heat to a print medium to generate text and/or images on the print medium. For example, a thermal printing device may represent information on a print medium by applying heat to portions of the print medium. As used herein, a “thermal printing device” refers to any hardware device with functionalities to physically produce representation(s) (e.g., text, images, models, etc.) on a medium. As used herein, a “medium” and/or “print medium” may include a thermally activated print medium. As used herein, a “thermally activated print medium” refers to a coated thermochromic (e.g.; thermal) medium. Some thermally activated print media may comprise stacked layers of thermally reactive layers, each layer reactive to different temperatures and producing a different color.

Due, for instance, to stacked layer of media, variability may occur during pixel activation of a thermally activated print medium. For instance, thermal energy applied during pixel activation may inadvertently cause an overlap in color on a pixel of thermally activated print medium. For example, a printhead may receive overlapping color signals, which may cause the printhead to activate multiple colors in the same region of the pixel thereby resulting in color overlap. As used herein, “overlap” may refer to a region with multiple activated colors. Such color overlap may reduce the color quality of the pixel, cause poorly representation of information on the thermally activated print medium, and/or result in a smaller color gamut. As used herein, “activated colors” refer to colors formed on the thermally activated print medium due to activation of the thermally activated print medium.

As such, thermal printing devices, as described herein, may control color overlap and spread activated colors throughout the pixel more evenly, such as to optimally fill whitespace. That is, the thermal printing device may predetermine the voltage pulse pattern information and the location and/or region of the pixel the voltage pulse patterns are to activate to produce color. In addition, the thermal printing device may use a distinct voltage pulse pattern to activate overlapping color regions to control when and where overlapping colors occur. Accordingly, this disclosure is directed to system that more optimally fill whitespace in a pixel, minimize and control color overlap in a pixel, and/or produce larger color gamut.

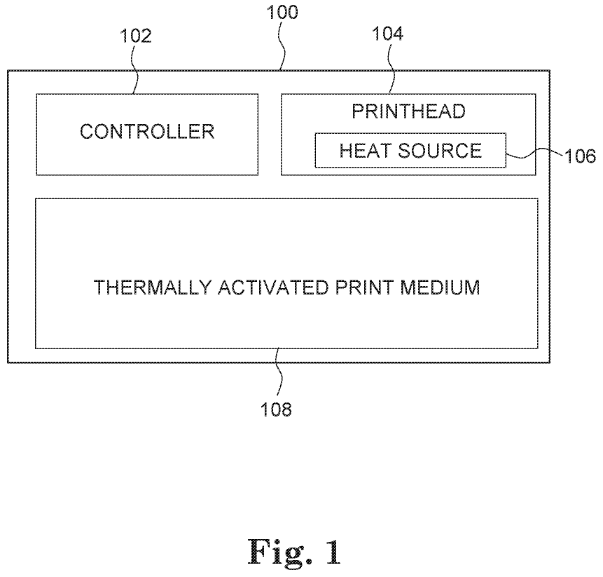

FIG. 1 illustrates an example system 100 including a thermal printing device. System 100 may be implemented in a variety of imaging systems, such as printers, copiers, etc., for example. The system 100 may include a printhead 104 comprising a heat source 106. In some examples, the printhead 104 may transmit heat from the heat source 106 onto a thermally activated print medium 108.

In some examples, thermally activated print medium 108 may include a yellow layer, a magenta layer, and a cyan layer. The layers of thermally activated print medium 108 may be layers including colorless crystals of amorphochromic dyes which may convert to colored form when melted and retain color after re-solidification. In some examples, the top layer of thermally activated print medium 108 may be yellow, the middle layer may be magenta, and the bottom layer may be cyan. In some examples, the printhead 104 may channel heat from the heat source 106 to produce physical representations on thermally activated print medium 108. For example, the heat source 106 may generate heat and heat the printhead 104 to varying temperatures to produce a physical representation (e.g., text, images, models, etc.) on thermally activated print medium 108. As used herein, “printhead” may refer to a component in a thermal printing device that causes physical representations, such as text, images, models, etc., to occur on a thermally activated print medium. While some elements are designated as a “top,” “middle,” or a “bottom” it should be understood that such elements may correspond to other relative terms or possible orientations in some applications in order to practice the examples of this detailed description.

In some examples, a printhead 104 may activate the different layers of the thermally activated print medium 108. In some examples, the printhead 104 may produce color by applying heat at different temperatures to activate different layers of the thermally activated print medium 108. In addition, the printhead 104 may apply heat to the thermally activated print medium 108 for varying periods of time. For example, the printhead 104 may apply a high amount of heat to the thermally activated print medium 108 for a short amount of time to activate a top layer. The printhead 104 may apply a low amount of heat to the thermally activated print medium 108 for a long period of time to activate a bottom layer. As used herein, “activation” refers to a layer of thermally activated print medium developing color as a result of the temperature applied to thermally activated print medium.

In some examples, a printhead 104 may activate the thermally activated print medium 108 by sending a pulse of heat to the thermally activated print medium 108. In some examples, the printhead 104 may send sequential on and off heat pulses to activate the thermally activated print medium 108. That is, the printhead 104 may send on and off heat pulses to the thermally activated print medium 108 in a predetermined order to produce representations on the thermally activated print medium 108. In some examples, the sequential on and off heat pulses may produce a pattern of heat pulses or a voltage pulse pattern that may produce representations on the thermally activated print medium 108. As used herein, “voltage pulse pattern” refers to a set of on and off heat pulses to activate thermally activated print medium. In some examples, different voltage pulse patterns may form different color markings on thermally activated print medium 108 to form a pixel. That is, different voltage pulse patterns may activate different primary colors, secondary colors, tertiary colors, etc. to form a pixel. As used herein, “pixel” refers to the basic unit of programmable color on a thermally activated print medium.

In some examples, an increased amount of heat pulses sent by the printhead 104, within a given time, may cause the temperature of the printhead 104 to increase and produce high temperature colors. For example, the voltage pulse pattern may reduce the amount of time between heat pulses to increase the amount of heat pulses within a set time and produce high temperature colors. In some examples, a decreased amount of heat pulses sent by the printhead 104, within a given time, may cause the temperature of the printhead 104 to decrease and produce low temperature colors. For example, the voltage pulse pattern may increase the amount of time between heat pulses to decrease the amount of heat pulses within a set time and produce low temperature colors. That is, the temperature of the printhead 104 is based on an amount of pulses produced by the voltage pulse pattern within a set time. In addition, the color produced on the thermally activated print medium 108 is determined by the temperature of the printhead 104 during activation of the thermally activated print medium 108. In various examples, the printhead 104 may activate a plurality of regions of the thermally activated print medium 108 to form a pixel in an individual pass. In various examples, the printhead 104 may activate a plurality of regions of the thermally activated print medium 108 to form a pixel in a plurality of passes.

In some examples, the printhead 104 may receive voltage pulse pattern information to print on thermally activated print medium 108 with a printhead 104. As used herein, “voltage pulse pattern information” refers to information relating to the release of a heat pulse by the printhead on to a thermally activated print medium. For example, voltage pulse pattern information may include information about the length of a pulse, the length of time between pulses, the temperature of a pulse, the location and/or region the pulse is to activate, etc. In some examples, the voltage pulse pattern information may allow the printhead 104 to activate an individual pixel of the thermally activated print medium 108. For examples, the printhead 104 may form markings on a plurality of regions of the thermally activated print medium 108 using heat pulses based on voltage pulse pattern information to produce representations on the thermally activated print medium 108. As used herein, “markings” refers to an area on the thermally activated print medium that has a color different from its surroundings and is produced by applying or transmitting heat to the thermally activated print medium.

The system 100 may include a controller 102, as illustrated in FIG. 1. In some examples, the controller 102 may divide the thermally activated print medium 108 into regions based on the voltage pulse pattern information to form a pixel. For example, the controller 102 may divide portion of the thermally activated print medium 108 into regions the printhead 104 may apply heat to and form a pixel.

In some examples, the controller 102 may send the voltage pulse pattern information to the printhead 104. In some examples, the controller 102 sending the voltage pulse pattern information to the printhead 104 may allow the printhead to form markings on and/or activate a plurality of regions of the thermally activated print medium 108. In some examples, the controller 102 may send a series of voltage pulse pattern to the printhead 104, based on the voltage pulse pattern information. In some examples, the voltage pulse pattern information sent by the controller is comprised of sequential on and off heat pulses. As used herein, “series of voltage pulse patterns” refers to multiple sets of heat pulses and/or voltage pulse patterns.

In some examples, the controller 102 may determine a plurality of voltage pulse patterns prior to the activation and/or the formation of markings on the plurality of regions to produce a representation on the thermally activated print medium 108. In addition, the controller 102 may determine the specific location and/or region of the thermally activated print medium 108 a particular voltage pulse pattern is to activate prior to the formation of the markings on the plurality of regions. In some examples, the plurality of voltage pulse patterns are made up of similar and different voltage pulse patterns that produce similar and different colors during the print process. For example, a first voltage pulse pattern may produce a blue color on the thermally activated print medium 108 and the second voltage pulse pattern may produce a yellow color on the thermally activated print medium 108. In some examples, predetermining a voltage pulse pattern and the region it is to activate may optimally fill whitespace.

For example, predetermining the voltage pulse patterns and the regions the voltage pulse patterns are to activate may ensure that adjacent regions do not have the same activated color. In some examples, same activated colors of the thermally activated print medium are separated by one region of the thermally activated print medium. In addition, determining the plurality of voltage pulse patterns may spread colors evenly through the regions of the thermally activated print medium 108 to form a pixel and ensure that adjacent regions have different activated colors. In some examples, ensuring that adjacent regions have different activated colors may form a pixel and fill whitespace more optimally in the formed pixel. In some examples, having adjacent regions that do not have the same activated color may reduce the amount of unwanted whitespace, produce larger color gamut, and reduce image grain. As used herein, “different activated colors” refers to colors that are not identical and/or the same and formed on the thermally activated print medium due to activation of the thermally activated print medium. As used herein, “same activated colors” refers to colors that is identical or exactly similar to the original color and formed on the thermally activated print medium due to activation of the thermally activated print medium. It should be understood that when an element is referred to as being “adjacent” to another element, it may be on, in contact, connected, next to, or coupled with the other element.

In some examples, predetermining the voltage pulse patterns and the locations they are to activate may allow for predetermined overlap regions. In some examples, predetermining the overlap regions of the thermally activated print medium 108 may control the amount of overlapping regions that are produced in the formed pixel. Predetermining the overlap regions of the thermally activated print medium 108 may allow for control of the location and time at which an overlap region will occur in the formed pixel. That is, predetermined overlap regions may produce larger color gamut and/or reduce image grain of the representation produced on the thermally activated print medium 108.

In some examples, each voltage pulse pattern may activate a specific color on the thermally activated print medium 108 to form a pixel. In some examples, an overlap region of a pixel may be a region that is made up of multiple activated colors. In some examples, an overlap region may be activated with an individual voltage pulse pattern that is distinct and different than the sum of the voltage pulse patterns used to activate the multiple colors that make up the overlap region. That is, the individual voltage pulse pattern used to activate the overlap region may activate multiple colors.

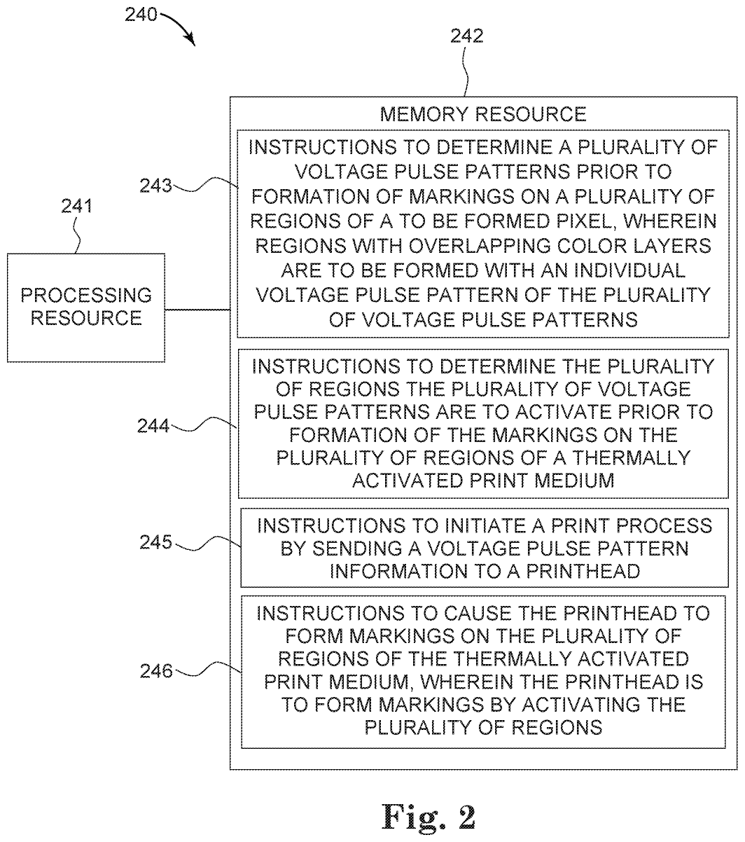

FIG. 2 illustrates an example apparatus 240 including a thermal printing device. As illustrated in FIG. 2, the apparatus 240 includes a processing resource 241 and a memory resource 242. The processing resource 241 may be a hardware processing unit such as a microprocessor, application specific instruction set processor, coprocessor, network processor, or similar hardware circuitry that may cause machine-readable instructions to be executed. In some examples, the processing resource 241 may be a plurality of hardware processing units that may cause machine-readable instructions to be executed. The processing resource 241 may include central processing units (CPUs) among other types of processing units. The memory resource 242 may be any type of volatile or non-volatile memory or storage, such as random-access memory (RAM), flash memory, read-only memory (ROM), storage volumes, a hard disk, or a combination thereof.

The memory resource 242 may store instructions thereon, such as instructions 243, 244, 245, and 246. When executed by the processing resource 241, the instructions may cause the apparatus 240 to perform specific tasks and/or functions. For example, the memory resource 242 may store instructions 243 which may be executed by the processing resource 241 to cause the apparatus 240 to determine a plurality of voltage pulse patterns prior to formation of markings on a plurality of regions of a to be formed pixel, wherein regions with overlapping color layer are to be formed with an individual pulse pattern of the plurality of voltage pulse patterns. For example, the voltage pulse patterns and the regions the voltage pulse patterns are to activate may be predetermined to spread color evenly throughout the thermally activated print medium and more optimally fill whitespace in the formed pixel. In some examples, regions with overlapping color layers may be activated and/or formed with an individual voltage pulse pattern.

The memory resource 242 may store instructions 244 which may be executed by the processing resource 241 to cause the apparatus 240 to determine the plurality of regions the plurality of voltage pulse patterns are to activate prior to formation of the markings on the plurality of regions of a thermally activated print medium. In some examples, the regions the voltage pulse patterns are to activate may be predetermined to ensure that adjacent regions have different activated colors, control the regions with overlapping colors, etc.

The memory resource 242 may store instructions 245 which may be executed by the processing resource 241 to cause the apparatus 240 to initiate a print process by sending a voltage pulse pattern information to a printhead. In some examples, sending voltage pulse pattern information to a printhead may allow the printhead to activate the thermally activated print medium and form an individual pixel. For examples, the printhead may activate a plurality of non-continuous regions of thermally activated print medium to form a pixel, using heat pulses based on voltage pulse pattern information.

The memory resource 242 may store instructions 246 which may be executed by the processing resource 241 to cause the apparatus 240 to cause the printhead to form markings on the plurality of regions of the thermally activated print medium, wherein the printhead is to form markings by activating the plurality of regions. For example, the printhead may activate and/or form markings on specific regions of the thermally activated print medium with the voltage pulse pattern. In some examples, activating specific regions of the thermally activated print medium with prespecified voltage pulse patterns may more optimally fill whitespace in a formed pixel and control color overlap.

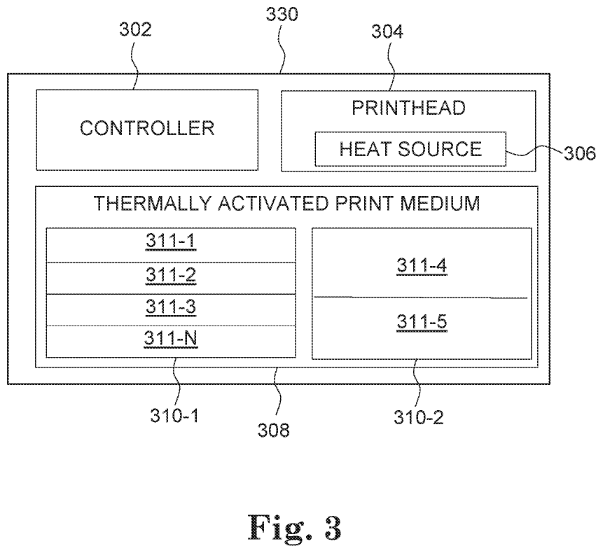

FIG. 3 illustrates an example thermal printing device 330. The thermal printing device 330 may include a heat source 306 to heat the thermal printing device 330. In some examples, the thermal printing device 330 may use the heat source 306 to print on thermally activated print medium 308. For example, the heat source 306 may print text, images, etc. on thermally activated print medium 308.

In some examples, thermally activated print medium 308 may include a plurality of layers. In some examples, the plurality of layers may produce different colors when activated by the printhead 304. For examples, the thermally activated print medium 308 may have a yellow layer, a magenta layer, and a cyan layer. In some examples, higher temperatures and longer periods of heat may be used to activate lower layers of the thermally activated print medium 308.

For examples, a printhead 304 may focus heat from a heat source 306 to produce physical representations and/or markings and activate the layers of the thermally activated print medium 308. In some examples, the printhead 304 may apply different temperatures to activate and/or form markings on different layers of the thermally activated print medium 308. In some examples, different layers of the thermally activated print medium may activate based on the amount of heat applied over a set time. For example, the printhead 304 may apply a high temperature to the thermally activated print medium 308 for a long time to activate a bottom layer.

In some examples, a printhead 304 may print on the thermally activated print medium 308 by sending a pulse of heat. In some examples, the printhead 304 may send sequential on and off heat pulses to form a pixel 310 on the thermally activated print medium 308. In some examples, the sequential on and off heat pulses may be considered voltage pulse patterns.

In some examples, higher temperature colors may be produced when the printhead 304 send an increased amount of heat pulses, within a set time, to the thermally activated print medium 308. In various examples, increasing the amount of heat pulses the printhead 304 sends within a set time may increase the temperature of the printhead 304. In some examples, lower temperature colors may be produced when the printhead 304 send a decreased amount of heat pulses, within a set time, to the thermally activated print medium 308. In various examples, decreasing the amount of heat pulses the printhead 304 sends, within a set time, may decrease the temperature of the printhead 304.

The thermal printing device 330 may include a controller 302, as illustrated in FIG. 3. In some examples, the controller 302 may receive color information to form markings on thermally activated print medium 308 to form a pixel 310. As used herein, “color information” refers to information relating to a physical representation to be printed on thermally activated print medium 308. For example, color information may include values of amounts of color to be used at different locations and/or regions on thermally activated print medium 308. In some examples, the controller 302 may receive color information from, for example, a computing device, although examples of the disclosure are not so limited.

In some examples, the color information may include values of amounts of color and the locations and/or regions of the thermally activated print medium 308 to generate a physical representation on. In some examples, the color information may include values of amounts of color and intensity levels of the color for a plurality of regions 311-1, 311-2, 311-3, and 311-N to form a pixel 310-1.

For example, the color information may cause the printhead 304 to produce lighter less intense colors in certain regions 311 to form a pixel 310 and darker more intense colors in other regions 311 to form the pixel 310. Regions 311 collectively refers to 311-1, 311-2, 311-3, and 311-N and/or 311-4 and 311-5. That is, producing lighter less intense colors and darker more intense colors in certain regions 311 may reduce variation in lightness and darkness over the length of the formed pixel 310 and spread colors evenly throughout the formed pixel 310 reducing whitespace. In some examples, the lighter less intense colors may encompass the entire pixel 310 that may be formed to create larger color pixels without whitespace or with limited whitespace. That is, creating lighter less intense colors that encompass a majority of the formed pixel 310 may optimally fill whitespace and/or reduce the amount of whitespace in the formed pixel 310.

In some examples, the controller 302 may divide the thermally activated print medium 308 into a plurality of regions 311. For example, the controller 302 may separate the thermally activated print medium 308 into regions 311-1, 311-2, 311-3, and 311-N to allow the printhead 304 to activate and form marking on specific areas of the thermally activated print medium 308 to form a pixel 310-1. In some examples, the controller 302 may divide the thermally activated print medium 308 into regions 311 based on the voltage pulse pattern information. In some examples, controller 302 may determine voltage pulse pattern information to activate regions 311-4 and 311-5 based on the received color information.

For example, based on the color information the controller 102 may determine that a pixel 310-2 should contain sixty percent cyan and sixty percent magenta to form a pixel 310-2 with blue, cyan, and magenta. The controller may then divide the thermally activated print medium 308 into two regions 311-4 and 311-5, determine the voltage pulse patterns to produce the blue, cyan, and magenta colors, and determine the regions the voltage pulse patterns are to activate. In addition, the controller 102 may activate forty percent of the thermally activated print medium 308 to form a pixel 310-2 with cyan with a first voltage pulse pattern, activate forty percent of the thermally activated print medium 308 to form the pixel 310-2 with magenta with second voltage pulse pattern, that is different from the first, and activate twenty percent of the thermally activated print medium 308 to form the pixel 310-2, to make an overlap region with both magenta and cyan activation, with a third voltage pulse pattern that is different from the first and second voltage pulse pattern. That is, the blue region of the formed pixel 310-2 is produced by activating both magenta and cyan in the joint portion of both regions 311-4 and 311-5.

In some examples, the controller 302 may cause a printhead to print and/or form markings on a plurality of divided regions 311. For examples, the controller 302 may cause a printhead 304 to activate and/or form markings on the regions until a threshold intensity level is reached. In some examples, the threshold intensity level is determined by the color information.

In some examples, the controller 302 may send the voltage pulse pattern information to the printhead 304. In some examples, the controller 302 may send voltage pulse pattern information to the printhead 304 to activate and/or form markings on thermally activated print medium 308 to form an individual pixel 310 by apply heat to a particular region 311 using the printhead 304. For examples, the printhead 304 may activate a plurality of regions 311 using heat pulses based on voltage pulse pattern information sent by the controller 302. In some examples, the controller 302 may send a series of heat pulses to the printhead 304 based on the determined voltage pulse pattern information.

Although controller 302 is illustrated in FIG. 3 as being included in the thermal printing device 330, examples of the disclosure are not so limited. For example, the controller 302 may be remote from the thermal printing device 330 and may communicate with the thermal printing device 330 via a network relationship, such as a wired or wireless network.

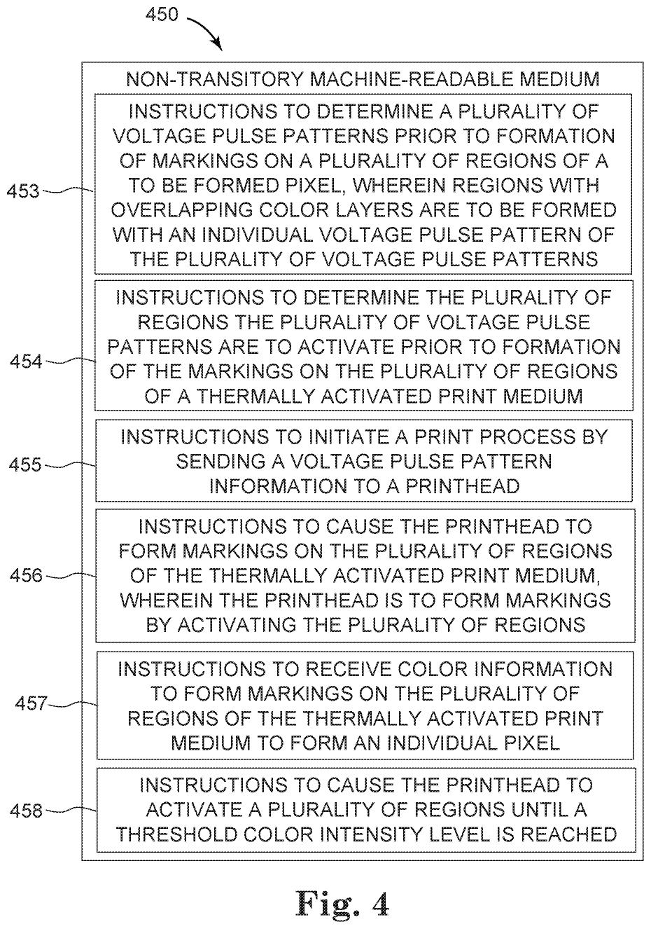

FIG. 4 illustrates an example diagram of a medium 450 including a thermal printing device. A processing resource may execute instructions stored on the non-transitory machine-readable medium 450. The non-transitory machine-readable medium 450 may be any type of volatile or non-volatile memory or storage, such as random-access memory (RAM), flash memory, read-only memory (ROM), storage volumes, a hard disk, or a combination thereof.

The medium 450 stores instructions 453 executable by a processing resource to determine a plurality of voltage pulse patterns prior to formation of markings on a plurality of regions of a to be formed pixel, wherein regions with overlapping color layer are to be formed with an individual voltage pulse pattern of the plurality of voltage pulse patterns. In some examples, predetermined voltage pulse patterns may more optimally fill whitespace and control color overlap.

The medium 450 stores instructions 454 executable by a processing resource to determine the plurality of regions the plurality of voltage pulse patterns are to activate prior to formation of the markings on the plurality of regions of a thermally activated print medium. In some examples, determining the regions the voltage pulse patterns are to activate may spread colors evenly throughout the formed pixel.

The medium 450 stores instructions 455 executable by a processing resource to initiate a print process by sending a voltage pulse pattern information to a printhead. In some examples, sending voltage pulse pattern information to the printhead may allow the printhead to activate the thermally activated print medium and form an individual pixel. For examples, the printhead may activate a plurality of regions of a thermally activated print medium to create physical representations and/or markings on the thermally activated print medium.

The medium 450 stores instructions 456 executable by a processing resource to cause the printhead to form markings on the plurality of regions of the thermally activated print medium, wherein the printhead is to form markings by activating the plurality of regions. For example, the printhead may activate specific regions of the thermally activated print medium to more optimally fill whitespace and control the regions with color overlap.

The medium 450 stores instructions 457 executable by a processing resource to receive color information to form markings on the plurality of regions of the thermally activated print medium to form an individual pixel. In some examples, the color information may allow the printhead to produce and/or activate a color in a region of the thermally activated print medium. For example, the color information may provide information to produce color in specific regions of the thermally activated print medium to form a pixel as described herein.

The medium 450 stores instructions 458 executable by a processing resource to cause the printhead to activate a plurality of regions until a threshold color intensity level is reached. As used herein, “threshold color intensity level” refers to the amount of color used in a region of the thermally activated print medium to produce the amount of color determined by the color information. In some examples, the threshold color intensity level is determined by the color information. For example, the printhead may activate a plurality of regions of the thermally activated print medium to produce a color based on the data from the color information.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the detailed description. In addition, the proportion and the relative scale of the elements provided in the figures are intended to illustrate the examples of the detailed description and should not be taken in a limiting sense. That is, descriptions of various examples and figures may not be drawn to scale and thus, the descriptions may have a different size and/or configuration other than as shown therein. As used herein, the designator “N”, particularly with respect to reference numerals in the drawings, indicate that a plurality of the particular feature so designated can be included with examples of the description. The designator can represent the same or different numbers of the particular features. As used herein, “a plurality of” an element and/or feature can refer to more than one of such elements and/or features.

What is claimed:

1. A system for a thermal printing device, comprising:
a printhead comprising a heat source, wherein the printhead is to transmit heat from the heat source onto a thermally activated print medium to form markings on a plurality of regions of the thermally activated print medium to form a pixel; and
a controller to:
determine a plurality of voltage pulse patterns prior to formation of the markings on the plurality of regions;
determine which of the plurality of regions the plurality of voltage pulse patterns are to activate prior to formation of the markings on the plurality of regions, wherein regions with overlapping color layers are to be formed with an individual pulse pattern of the plurality of voltage pulse patterns; and
send a voltage pulse pattern information to the printhead.

2. The system of claim 1, wherein to determine the plurality of voltage pulse patterns comprises determining the plurality of voltage pulse patterns to evenly spread colors in the to be formed pixel and ensure that adjacent regions have different activated colors.

3. The system of claim 2, wherein same activated colors are separated by one region of the thermally activated print medium.

4. The system of claim 1, wherein the printhead is to form markings on the thermally activated print medium to form the pixel in an individual pass.

5. The system of claim 1, wherein the controller is to send voltage pulse pattern information to form markings on the plurality of regions of the thermally activated print medium to form an individual pixel.

6. The system of claim 1, wherein the voltage pulse pattern information is sent to the printhead in a series.

7. A non-transitory machine-readable medium storing instructions that, when executed by a processing resource, cause the processing resource to:
determine a plurality of voltage pulse patterns prior to formation of markings on a plurality of regions of a to be formed pixel, wherein regions with overlapping color layers are to be formed with an individual voltage pulse pattern of the plurality of voltage pulse patterns;
determine the plurality of regions the plurality of voltage pulse patterns are to activate prior to formation of the markings on the plurality of regions of a thermally activated print medium;
initiate a print process by sending a voltage pulse pattern information to a printhead; and
cause the printhead to form markings on the plurality of regions of the thermally activated print medium, wherein the printhead is to form markings by activating the plurality of regions.

8. The medium of claim 7, further including instructions to receive color information to form markings on the plurality of regions of the thermally activated print medium to form an individual pixel.

9. The medium of claim 7, further including instructions to cause the printhead to activate a plurality of regions until a threshold color intensity level is reached.

10. The medium of claim 7, wherein the plurality of voltage pulse patterns are made up of similar and different voltage pulse patterns that produce similar and different colors during the print process.

11. A thermal printing device comprising:
a printhead to form markings on a plurality of regions of a thermally activated print medium to form a pixel; and
a controller to:
receive color information to form markings on the thermally activated print medium to form an individual pixel;
determine a plurality of voltage pulse patterns to activate the plurality of regions of the thermally activated print medium to form the pixel, wherein regions with overlapping color layers are to be formed with an individual voltage pulse pattern of the plurality of voltage pulse patterns;
determine which of the plurality of regions the plurality of voltage pulse patterns are to activate prior to formation of the markings on the plurality of regions; and
send the voltage pulse pattern information to the printhead.

12. The thermal printing device of claim 11, wherein the printhead is to form markings on thermally activated print medium to form the pixel in a plurality of passes.

13. The thermal printing device of claim 11, wherein the voltage pulse pattern information sent by the controller is comprised of sequential on and off heat pulses.

14. The thermal printing device of claim 11, wherein a temperature of the printhead is based on an amount of pulses produced by the voltage pulse pattern within a set time.

15. The thermal printing device of claim 14, wherein a color produced on the thermally activated print medium is based on the temperature of the printhead during a print process.
